(19) United States
(12) Patent Application Publication
(10) Pub. No.: US 2003/0172185 A1
(43) Pub. Date: Sep. 11, 2003

(54) Method and system for adding text data to data communication sessions

(75) Inventor: Anthony J. Dezonno, Bloomingdale, IL (US)

Correspondence Address: Welsh & Katz, Ltd., Eric D. Cohen, 22nd Floor, 120 South Riverside Plaza, Chicago, IL, 60606, US

(73) Assignee: Rockwell Electronic Commerce Technologies, L.L.C., Wood Dale, IL

(21) Appl. No.: 10/093,192

(22) Filed: Mar. 7, 2002

(51) Int. Cl. G06F 15/16

(52) U.S. Cl. 709/246

(57) ABSTRACT

A method for adding text data to data communication sessions in a transaction processing system handling non-voice dialog communication between an agent and a caller includes the steps of a) establishing the non-voice dialog communication between the caller and the agent, b) acquiring predetermined text data during the communication between the agent and the caller, c) populating at least one text storage location with the acquired text data, d) inserting the text storage location data into a portion of a template text message to generate a customized text message, and e) transmitting the customized text message to the caller during the non-voice dialog communication, the agent transmitting the customized text message at a predetermined time during the communication.

### FIELD OF THE INVENTION

The present invention relates generally to a method and system for routing calls to agents of a transaction processing system and/or an automatic call distribution system (“ACD”), and more specifically to a method and system for transmitting customized “canned” messages from the agent to the caller during non-voice dialog communication

### BACKGROUND

Systems which automatically distribute customer contacts or calls (generically referred to as “ACD”) are often employed in telemarketing environments in which agents stationed at agent telephone sets answer many different types of telephone calls and other types of customer contacts (e.g., VoIP, emails, facsimile, chat room dialog, instant messages, other Internet contacts, etc.) from customers during a work day. As referred to herein, an ACD may be referred to as an automatic call distributor or an automatic contact distributor because the ACD handles a variety of communication media. In other words, the ACD handles many forms of communication, not just telephone calls in which a potential customer speaks with an agent. The term “ACD” may apply to any type of transaction processing system, and need not apply only to dedicated telemarketing systems or automatic call distributors. In some known ACD's, the agent may receive certain information about the type of customer call (i.e. contact) on a visual display at the agent set when a call or contact is distributed to the agent. An ACD is any such system which performs these functions and, for example, may employ a wide variety of architectures including integrated centralized systems, distributed systems, systems using one or more personal computers or servers, etc.

In some embodiments, ACD's may be used to support a number of different vendors in their telemarketing effort, and in such marketing environments, the agent is typically in communication with the customer or potential customer with respect to or on behalf of a particular vendor. The next contact that the agent processes may be on behalf of the same vendor or on behalf of a different vendor. In another embodiment, ACD's may be used exclusively by or on behalf of a single vendor such that all of the contacts processed by the agent involve one particular vendor.

Often, a customer call is distributed to an agent that involves interactive voice dialog. This means a normal two-way verbal exchange. An ACD, however, may also distribute a non-voice dialog contact or call to the agent. This does not involve direct two-way speech between the agent and the customer or caller. Non-voice dialog communication may be, for example, emails, facsimile, chat room dialog, instant messaging, Internet, etc. and the like. This is becoming more common as Internet traffic and electronic sales transactions increase. Handling of the non-voice dialog contact may require a specialized device or subcomponent of the ACD. In this situation, the agent may typically view text on a display screen that the caller typed in or transmitted. In response, the agent may provide information to the contact or request information from the caller, via the keyboard or other input device. Essentially, the dialog between the agent and the caller occurs on a display screen. Further, the agent may handle multiple calls. For example, the agent may typically handle two to five (or more) simultaneous non-voice dialog communications or transactions, which may be presented as two to five separate dialog windows on the display screen, which windows may, for example, be tiled or layered. Of course, the number of simultaneous transactions may vary significantly.

Often, in text based communication between the caller and the agent, much of the data typed by the agent is repetitive or has been previously received, or is known. In particular, the greeting and the farewell messages, and dialog in between, contain information that was previously typed in by either the caller or the agent. For example, once the agent knows the caller's name, subsequent text that the agent types, and especially the farewell message, will contain the caller's name. For example, when the agent terminates the communication, he or she may typically type “Mr. Smith, thank you for buying your product from the Acme Company.” Typing in such known information by the agent is redundant and inefficient. It is also prone to inaccuracy by mis-typing, typographical errors, or poor spelling and grammar skills. It is desirable to provide a telecommunication system that automatically “builds” or inserts text into portions of sentences and/or builds entire sentences, which the agent can transmit to the caller at the appropriate time.

### SUMMARY

The disadvantages of present transaction processing systems are substantially overcome with the present invention by providing a novel method and system for adding text data to data communication sessions.

More specifically, a method for adding text data to data communication sessions in a transaction processing system handling non-voice dialog communication between an agent and a caller according to one embodiment of the present invention includes the steps of: a) establishing a non-voice dialog communication between the caller and the agent, b) acquiring predetermined text data during the communication between the agent and the caller, c) populating at least one text storage location with the acquired text data, d) inserting the text storage location data into a portion of a template text message to generate a customized text message, and e) transmitting the customized text message to the caller during the non-voice dialog communication, the agent transmitting the customized text message at a predetermined time during the communication.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a pictorial representation of a specific embodiment of a transaction processing system showing a customer computer and an exemplary automatic call distributor;

FIG. 2 is a block diagram of a specific example of a known automatic call distributor system;

FIG. 3 is an exemplary high-level flowchart showing various steps according to one embodiment of a specific method for inserting text data into data sessions; and

FIG. 4 is a pictorial diagram of an exemplary display screen presented to an agent.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

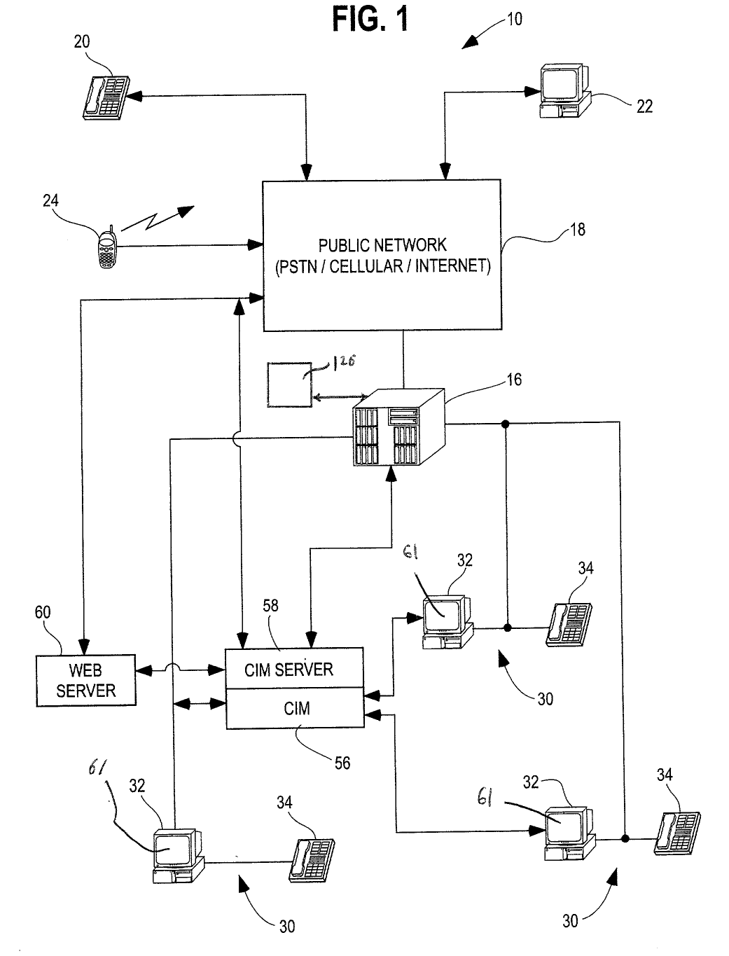

Referring now to FIG. 1, an exemplary embodiment of a system 10 for facilitating routing of incoming calls or contacts (“transactions”) to agents associated with a transaction processing system, which may also be referred to as an automatic call distribution or automatic contact distribution system (ACD) 16, is shown generally. The ACD 16 processes both voice-dialog communications or transactions, as well as non-voice dialog communications and transactions, as described hereinafter. The present invention may be implemented in numerous types and sizes of systems for distributing calls to selected ones of a plurality of agents. Examples of ACD systems that may be used in the present invention are the SPECTRUM ACD and Transcend ACD products available from Rockwell FirstPoint Contact.

Other types of call distribution systems including, for example, distribution systems or those using one or more personal computers or servers, may also be used. Some other suitable ACD's are disclosed in U.S. Pat. No. 5,268,903, issued to Jones et al. on Dec. 7, 1993, entitled “Multichannel Telephonic Switching Network With Different Signaling Formats and Connect/PBX Treatment Selectable For Each Channel,” U.S. Pat. No. 5,140,611, issued to Jones et al. on Aug. 18, 1992, entitled “Pulse width Modulated Self-Clocking and Self-Synchronizing Data Transmission and Method for a Telephonic Communication Switching System,” U.S. Pat. No. 5,127,004, issued to Lenihan et al. on Jun. 30, 1992, entitled “Tone and Announcement Message Code Generator for a Telephonic Switching System and Method,” U.S. Pat. No. 6,289,373 B1, issued to Dezonno on Sep. 11, 2001, entitled “Method of Processing E-Mail in an Automatic Call Distributor,” and U.S. Pat. No. 6,097,806, issued to Baker et al. on Aug. 1, 2000, entitled “ACD with Multi-Lingual Agent Position,” the disclosures of which are hereby incorporated by reference in their entirety.

A customer or caller may be connected to the ACD 16 through a public switched telephone network (PSTN) 18, which caller may connect to the PSTN through a standard telephone set 20, a computer 22, a cellular telephone 24, or any suitable communication device. Note that the term “caller” as used herein does not necessarily mean that the contact or person using the telephone 20, for example, initiated the call to the agent. Notably, the agent may have initiated the call to the contact. Accordingly, the term “caller” shall broadly refer to the contact or potential customer even though the agent may have originated or initiated the call or contact. Additionally, the term “call” may be a telephone call, or it may be any other form of communication (emails etc.) as set forth above.

In the illustrated embodiment, multiple agent stations or terminals 30 are shown coupled to the ACD 16. For purposes of illustration, only three agent stations are shown, but any suitable number of agents may be coupled to the ACD 16. The agent stations 30 may also include agent station computers 32 or terminals, and/or telephone sets 34.

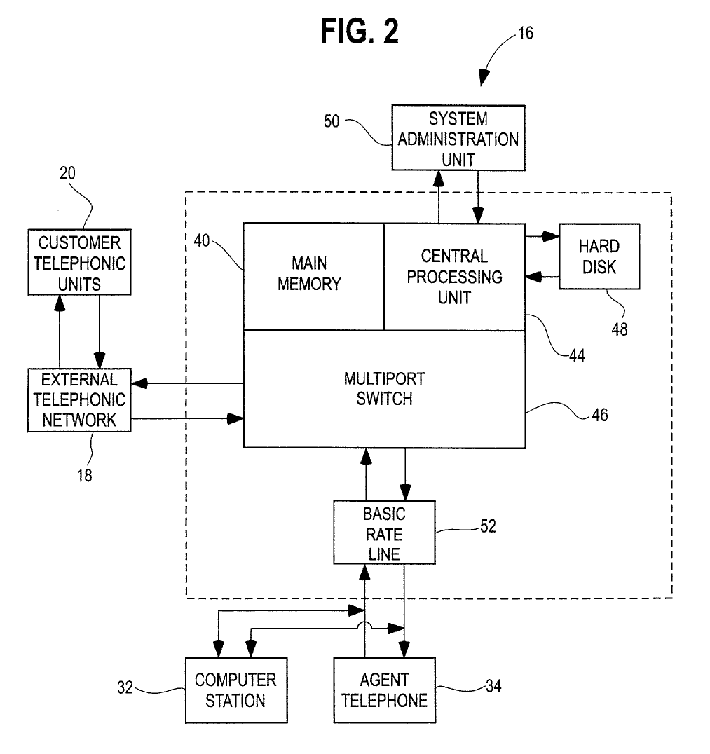

Referring now to FIGS. 1 and 2, FIG. 2 shows the an example of an ACD 16 in greater detail. The ACD 16 may comprise hardware and/or software and, for example, may include a main memory 40, a central processing unit 44 and a multiport switch 46, each of which may be separate units, distributed components, or integrated at a single location or single cabinet. The multiport switch 46 is coupled to the PSTN 18, which in turn, is connected to customer telephones 20 or other communication devices (20, 22, or 24). The central processing unit 44 may include storage, such as hard disk storage 48, and may also be coupled to a system administration unit 50. The ACD 16 is connected through a suitable communication link to the plurality of agent telephonic sets 34, for example, through a basic rate line 52, as is known in the art. The agent computer station 32 and the agent telephone sets 34 may be incorporated into a single unit, as is known in the art.

The illustrated ACD 16 may handle voice communication and may also handle non-voice communication, such as emails, facsimile, chat room dialog, instant messaging, Internet, etc. Non-voice dialog communication is another form of contact communication and the ACD 16, when configured and coupled to appropriate hardware and/or software devices, as described below, is not limited to processing voice-based telephone calls. The ACD 16 may be a single integrated device, or may include distributed hardware and software. In one specific embodiment, the SPECTRUM ACD product available from Rockwell FirstPoint Contact may include a non-voice dialog communication processor, such as a Contact Integration Manager (CIM) 56, which may, for example, be a CIM Release No. 1.1, which is also available from Rockwell FirstPoint Contact. In the specific embodiment shown, the communication processor 56 or CIM (also referred to as non-voice dialog communication processor or communication processor) may handle the non-voice dialog communication between the customer or caller, and the agent.

The communication processor 56 may be operatively coupled to the ACD 16 and to the agent computer 32 or agent stations 30. Typically, the communication processor 56 receives email, chat room dialog, facsimile, instant message, Internet communication, and the like from a communication processor server 58. The communication processor server 58, in turn, may receive additional non-voice dialog contact communication from a web server 60, which may be connected to the PSTN 18 or some other communication network, as is known in the art. In one specific embodiment, the communication processor 56 may be separate from the ACD 16 and operatively coupled to the ACD 16. Alternatively, the communication processor 56 may be integrated into a portion of the ACD 16 or any other processor or processors in the system. In another embodiment, at least a portion of the communication processor 56 functionality may be part of the agent station computer 32, which may be, for example, a personal computer. The communication processor 56 may be any suitable computing device, such as, for example a microprocessor, RISC processor, mainframe computer, work station, single-chip computer, distributed processor, server, controller, micro-controller, discrete logic computer, remote computer, personal computer, internet computer, web computer, and the like.

With respect to the method and system described in detail below, the term ACD 16 is used interchangeably to mean either the ACD and/or the communication processor 56, or a combination of both. Both terms relate to a “transaction processing system” and because the ACD 16 and the communication processor 56 may be so closely related or the functions so distributed that a meaningful distinction may not be able to be made with respect to which particular component is performing a specific step described. Accordingly, for purposes of illustration only, the below-described method will be described in terms of the ACD 16 performing the step, even though a separate component or subcomponent, such as the communication processor 56, may actually perform the step or process.

The communication processor 56 in the illustrated embodiment is configured to facilitate sending and receiving non-voice dialog communication between the caller and the agent or agent terminal 30, and to transmit a signal to the ACD 16 indicating that the communication processor received the non-voice dialog communication from the caller. The signal from the communication processor 56 to the ACD 16 creates a “call appearance” so that the ACD is brought into the communication “loop,” and is able to track the contact. The call appearance simulates to the ACD 16 the appearance of a voice-type call, even though a voice-type call is not present. Once the call appearance to the ACD 16 has been made, the ACD can queue and track the non-voice dialog communication to the appropriate agent as if the call were an ordinary interactive voice-dialog call, even though the ACD may not utilize or connect its voice channel to the agent. Rather, the communication processor 56 may handle the non-voice dialog communication and provide the call to the agent, and also inform the ACD 16 regarding the status and initiation of the call.

Accordingly, once the call appearance has been made, the ACD 16 in the illustrated embodiment of FIG. 1 selects a particular agent to receive the non-voice dialog communication from the communication processor 56, and then causes the non-voice dialog communication to be routed to the selected agent by the communication processor. In known automatic call distribution systems, selection of the agent is performed according to any suitable method including known methods, such as the agent's availability, time past since prior contact, number of calls previously processed by the agent, skill or efficiency rating of the agent, and the like.

When agents are dealing with non-voice dialog communication, such as email, chat room communication, instant messages, and the like, typical text-based communication may include a greeting, a discussion, and a farewell message, which terminates the discussion. Of course, either the agent or the potential customer may initiate the call. Typically, the initiator of the communication will identify himself and state why he is contacting the other party. The contacted party would then respond and a discussion would ensue. Either or both of the parties may end the communication with a farewell message.

During the discussion, much information is exchanged. For example, the names of each party may eventually be transmitted to the other party. Additionally, the customer's account number (assuming an existing customer or contact) may be provided to the agent by the customer. All of the text information sent to the agent by the caller appears on the agent station computer 32 or terminal. Depending upon the context of the communication, the agent may respond to the caller with a variety of “stock” or often repeated dialog, which stock dialog may only differ slightly depending upon the name of the caller or other parameters relating to the conversation. For example, if the customer calls the agent, he may transmit a greeting such as:

“Hello, my name is John Smith, and I would like to inquire about a product.”

The agent may then transmit a response such as:

“Thank you Mr. Smith for your email, my name is Tom Jones, and how can I be of help to you?”

A discussion would then ensue between the caller and the agent, and at the end of the dialog, the agent may, for example, transmit a farewell message such as:

“Mr. Smith, I hope we were able to be of help to you. If you have any further questions, please don't hesitate to contact me.”

Accordingly, it can be seen that an agent typically will repeat many of the stock phrases during the agent's working day where the stock phrases only differ by a few selected words, with the most obvious difference being the name of the customer. Moreover, the words unique to one particular communication with a given customer, such as the customer's name, may be used many times in different responses provided by the agent during that communication. It is inefficient for the agent to type the entire text of his message, particularly when such dialog is similar from call to call. In known transaction processing systems involving non-voice dialog communication, the agent must fully type his response. This is time consuming, inefficient, and error-prone, which translates into higher operating costs and reduced customer satisfaction for the business on behalf of whom the agent is working.

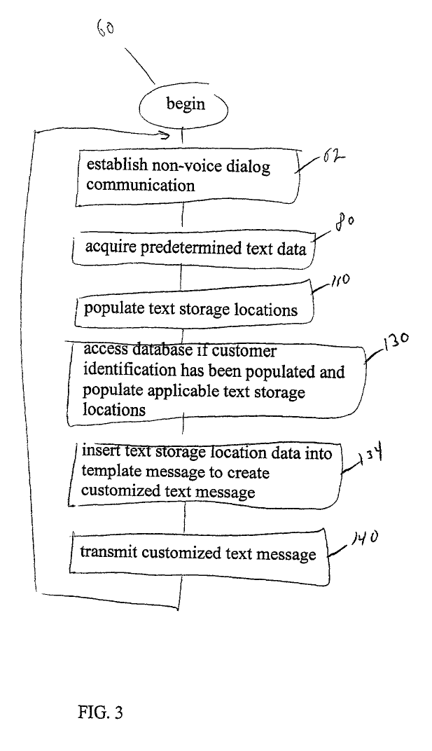

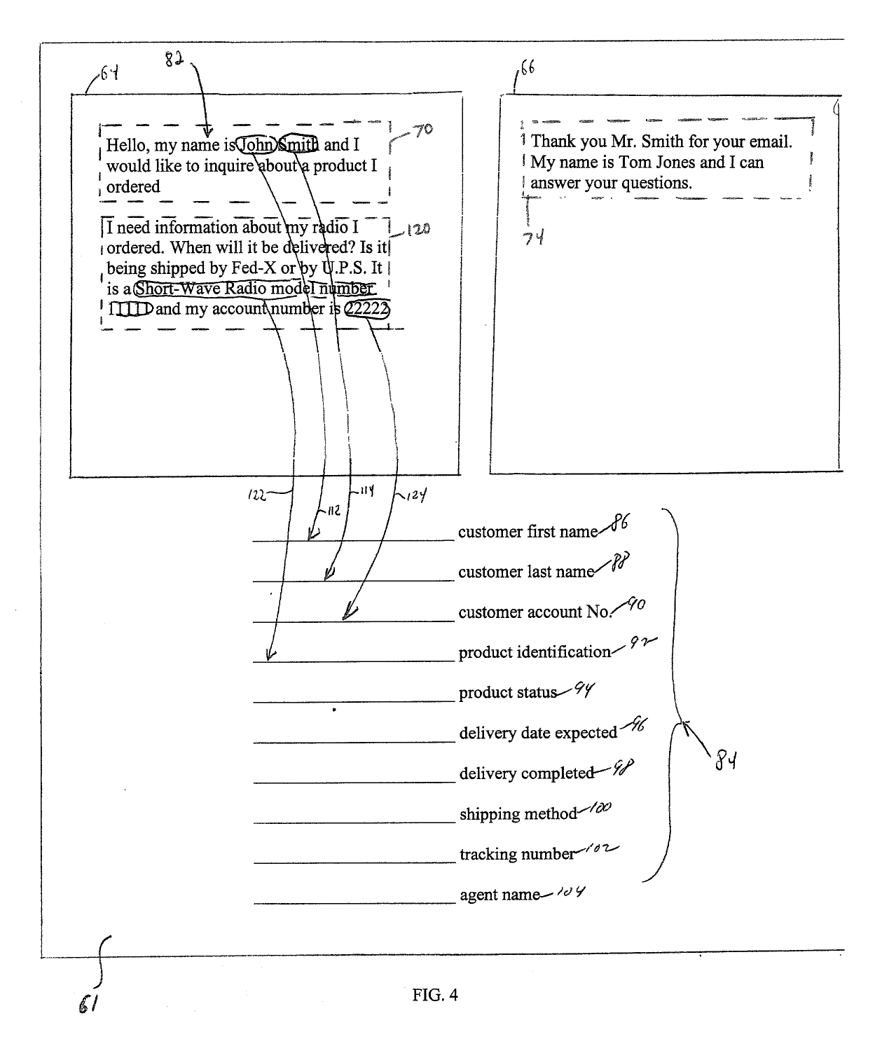

Referring now to FIGS. 3 and 4, FIG. 3 is a flowchart illustrating steps according to one example of the present embodiment, and FIG. 4 is a pictorial view of one example of a display screen 61 of the agent computer 32 presented to the agent of the transaction processing system 10 and/or communication processor 56. As show in a step 60, the example method begins. Next, in a step 62, the non-voice dialog communication between the caller and the agent is established. Either the agent may call the customer or potential customer, or the caller may call the agent. The display screen 61 of FIG. 4 in accordance with the example method of FIG. 3 may include a first dialog box 64 representing text sent from the caller to the agent, and a second dialog box 66 representing text sent from the agent to the caller. Each dialog box 64, 66 may be further divided into multiple scrolling portions so that a question asked, for example, by the caller, is shown in a first scrolling portion 70 of the first dialog box 64, and the response provided by the agent is shown in a first scrolling portion 74 of the second dialog box 66. Note that the corresponding scrolling portions 70, 74 are shown side-by-side on the agent's display screen 61 so that the agent can easily view a question and his response. The scrolling portions may be upwardly and downwardly scrolled, as is known in the art, to show previous text communication between the parties.

Alternatively, the agent may also be presented with a single dialog box (not shown) where each message is sequentially presented in a response/reply format. In other alternate embodiments, the scrolling portions may be color coded or numbered so that the agent can easily identify which portion is a reply to a previous question or statement.

Next, in a step 80, the agent acquires text data 82 (FIG. 3) during the communication between the agent and the caller. Preferably, such text data 82 may be acquired directly from the text in the first dialog box 64, as shown on the agent display screen 61. Typically, this text data is sent to the agent by the caller. In one embodiment, at least some of the text data may also be extracted automatically using, for example, text recognition software.

In one embodiment, the agent display screen 61 may include a plurality of text storage locations 84, which may for example, include Customer First Name 86, Customer Last Name 88, Customer Account Number 90, Product Identification 92, Product Status 94, Delivery Date Expected 96, Delivery Completed status 98, Shipping Method 100, Tracking Number 102, Agent Name 104, and the like. Any suitable number of text storage locations may be provided.

In one embodiment, the agent then may determine which data in the first dialog box 64 is pertinent and if it corresponds to the text storage locations 84. Preferably, once the agent receives the caller's text message on the display screen 61, he will have a nominal but sufficient period of time in which to populate the corresponding text storage locations 84 with the text data, as shown in a step 110. The agent may perform the population step 110 by using a graphical interface in the communication processor 56, as is known in the art. For example, as shown in FIG. 3, the agent may highlight and drag the customer's first name from the first scrolling portion 70 of the first dialog box 64 to the text storage location indicated by the Customer First Name 86, as shown by an arrow 112. Similarly, the agent may highlight and drag the customer's last name from the corresponding first scrolling portion 70 to the text storage location indicated by the Customer Last Name 88, as shown by an arrow 114. Of course, the agent may use any suitable method. For example, if the agent is more comfortable with typing than he is with using a mouse or other pointing device, the agent may directly type the text data into the corresponding text storage locations 84. This may be done at any time during the communication between the caller and the agent. Alternatively, the agent may use commercially available speech recognition software to manipulate text on the screen so as to populate the appropriate text storage locations. In another alternative, text recognition software may be used to automatically manipulate the text to populate the appropriate text storage location.

As the non-voice dialog communication between the agent and the caller continues, additional information may be exchanged. As shown in a second scrolling portion 120 of the first dialog box 64, the caller has provided an identification of the product of interest and his account number, and has also inquired about a delivery date and method of shipping. Accordingly, the agent may highlight and drag or use automatic text recognition software to insert the product identification into the text storage location indicated by the Product Identification, as shown by an arrow 122.

However, the agent need not necessarily populate all of the text storage locations 84 manually. For example, the second scrolling portion 120 of the first dialog box 64 shows that the customer provided his customer account number of 22222, which assumes of course, that the customer is a previous customer. In this situation, the agent may highlight and drag the customer's account number to the text storage location indicated by the Customer Account Number 90 (or automatic text recognition software may be used), as shown by an arrow 124. Because the customer provided his customer account number, additional information about the customer may be obtained from a database 126 (FIG. 1), which may be part of or external to the transaction processing system 10. Because the customer account number has been populated, the communication processor 56 may automatically access the customer's information based on the Customer Account Number 90. The communication processor 56 may then automatically populate the applicable text storage locations 84 corresponding to the Customer Account Number 90, as shown in a step 130.

For example, the communication processor 56 may automatically insert or populate the Delivery Date Expected 96, Shipping Method 100, Tracking Number 102, and Product Status 94, without agent intervention because this information was contained in the database corresponding to the caller.

The above example generally illustrates the dialog and the steps performed by the agent when a caller contacts the agent. Of course, as mentioned above, the agent may initiate contact with the customer. For example, the agent may send a text message to a customer or prospective customer, such as:

“Hello Mr. Smith, my name is Tom Jones and we are contacting individuals who subscribe to Radio Magazine to determine if you are interested in purchasing a short-wave Radio Model 11111.”

In the above example, the agent would at least have the potential customer's name, presumably from a “cold call” or other list, and would populate the Customer Last Name 88 text storage location, as shown in underlined text above.

After the applicable text storage locations 84 have been populated, either manually by the agent, or automatically, e.g., by the communication processor 56, the information contained in such text storage locations is preferably inserted into selected portions of a template text message, as shown in a step 134. The communication processor 56 may provide a plurality of template text messages, which are similar to “canned” or preprogrammed messages, but which are “customizable” in part. Various “blank” portions in the template text messages are configured to receive the corresponding data stored in the text storage locations 84. Some template text messages may only require a single insertion of acquired data, while other template text messages may require multiple insertions. Alternatively, text data may be entered directly into template message without use of the text storage locations.

For example, the template text message labeled as “A” below only requires insertion of the Customer Last Name 88, which is indicated in this document as underlined text:

A. Thank you, Mr. Smith for contacting us, how may I be of help?

Of course, the prefix of “Mr.,” “Ms.,” or “Mrs.” may be gleened from a gender based library of first names. If a name is ambiguous as to gender, both first and last names may be used.

Alternatively, the example template text message labeled as “B” below may requires insertion of both the Customer First Name 86 and the Customer Last Name 88, which is also indicated below as underlined text:

B. Thank you, John Smith for contacting us, how may I be of help?

The following example template text message labeled as “C” below requires insertion of the Customer First Name 86, Customer Last Name 88, Product Identification 92, Delivery Date Expected 96, and Shipping Method 100. Note also that the agent has caused his name and title to be inserted into the template text message. Of course, the Agent Name 104 data may be automatically populated by the communication processor 56 when the agent logs on to the transaction processing system 10:

C. Thank you, John Smith for contacting us. I researched your question and I am please to inform you that your Short-wave Radio model 11111 will be delivered on January 15^{th} by Federal Express. Have a great day. Thank you, Tom Jones account supervisor.

Of course, some of the predetermined text data may never be obtained, and therefore, some of the template text messages may not be completed. In such a situation, the template text message does not become a customized message and, hence is not sent to the caller. However, if the template text message is fully “filled in,” it is deemed to be a customized message, and may be sent. The agent may then elect to transmit the customized message to the caller, as shown in a step 140. Of course, the agent may decide to send the message, at his discretion, and at a predetermined time of his choosing during the dialog with the caller. He may also choose not to send a particular message, even if it is fully built or may choose to modify it before sending it.

Note that the step 110 shown in FIG. 3 (populating at least one text storage location) need not necessarily be performed as a separate step. Alternately, once the predetermined text data has been acquired, as shown in the step 80, such data may be stored directly into the corresponding blank portion of the template text message. For example, the agent may drag the predetermined text directly into a portion of the template text message, assuming that it is made visible on the agent display 61.

In one embodiment, the communication processor 56 does not display the template text messages on the agent display screen 61 until all of the blank portions have been filled in so as to create a customized text message. Thus, in this embodiment, the template text message need not be displayed until all of the corresponding text storage data 84 has been inserted or “dragged” from the various dialog boxes 64, 66 into the text storage locations. As mentioned above, once the data has been stored in the text storage locations 84, preferably, the communication processor 56 may cause that data to be inserted into the corresponding blank portions of the template text message.

In one alternate embodiment, the partially “built” template text messages may be displayed to the agent, but their appearance may be modified or altered, such as by “graying out” or partially shading the message to indicate to the agent that it is not yet fully “built.” As such, the message cannot yet be sent.

As described above, it can be seen that the customized messages may be “built” and completed during or prior to the non-voice dialog communication between the caller and the agent. The customized message may be sent as a greeting, as part of the ongoing discussion between the parties, and/or as a farewell message. Alternately, several customized messages may be created and may be ready to transmit to the customer. To provide a more “human” feel, if the agent is ready to transmit two customized messages, he may choose to separate or space apart transmission of the first and second customized messages by a predetermined time delay. Thus, the caller may assume that the agent is composing his response.

Specific embodiments of a method and system for adding text data to data communication sessions according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. In a transaction processing system, a method for inserting text data into a non-voice dialog communication between an agent of the transaction processing system and a caller, the method comprising the steps of:
a) acquiring predetermined text data during or prior to the communication between the agent and the caller;
b) inserting the predetermined text data into a portion of a template text message to generate a customized text message; and
c) transmitting the customized text message to the caller during the non-voice dialog communication, the agent transmitting the customized text message at a time during the communication.

2. The method according to claim 1 wherein at least a portion of the text data corresponds to data provided by the caller to the agent.

3. The method according to claim 1 wherein at least a portion of the text data is data contained in a text message sent by the caller.

4. The method according to claim 1 wherein at least a portion of the text data corresponds to data provided by the agent.

5. The method according to claim 1 wherein at least a portion of the text data is obtained from a database.

6. The method according to claim 1 wherein at least a portion of the text data is selected from the group consisting of a customer name, customer account number, product identification, product status, delivery date, delivery completed status, shipping method, and tracking number.

7. The method according to claim 1 further including the step of displaying a plurality of the template messages to the agent on a visual displace device.

8. The method according to claim 1 further including the step of not displaying the customized text message to the agent until all of the text data has been inserted into the template text message.

9. The method according to claim 1 further including the step of altering the visual appearance of the customized text message until all of the text data has been inserted into the template text message to indicate to the agent that the customized test message is not complete.

10. The method according to claim 1 wherein the agent transmits the customized text message as part of a greeting message or a farewell message.

11. The method according to claim 1 wherein the agent transmits the customized text message during the communication between the caller and the agent when sufficient predetermined text data has been acquired by the agent.

12. In a transaction processing system, a method for inserting text data into a non-voice dialog communication between an agent of the transaction processing system and a caller, the method comprising the steps of:
a) acquiring predetermined text data during the communication between the agent and the caller;
b) populating at least one text storage location with the acquired text data;
c) inserting the text storage location data into a portion of a template text message to generate a customized text message; and
d) transmitting the customized text message to the caller during the non-voice dialog communication, the agent transmitting the customized text message at a time during the communication.

13. The method according to claim 12 wherein at least a portion of the text data corresponds to data provided by the caller to the agent.

14. The method according to claim 12 wherein at least a portion of the text data is data contained in a text message sent by the caller.

15. The method according to claim 12 wherein at least a portion of the text data corresponds to data provided by the agent.

16. The method according to claim 12 wherein at least a portion of the text data is obtained from a database.

17. The method according to claim 12 wherein at least a portion of the text data acquired is selected by the agent for population into the at least one text storage location.

18. The method according to claim 12 wherein at least a portion of the text data is selected from the group consisting of a customer name, customer account number, product identification, product status, delivery date, delivery completed status, shipping method, and tracking number.

19. The method according to claim 12 further including the step of the agent using a graphical user interface to drag or copy the acquired text data into the at least one text storage location.

20. The method according to claim 12 further including the step of the agent re-typing the acquired text data into the at least one text storage location.

21. The method according to claim 12 further including the step of automatically recognizing and extracting text data and populating at least one text storage location with the extracted text data.

22. The method according to claim 12 further including the step of displaying a plurality of the template messages to the agent on a visual displace device.

23. The method according to claim 12 further including the step of automatically inserting the text storage location data into a predetermined position in the template text message.

24. The method according to claim 12 further including the step of automatically inserting a plurality of the text storage location data into predetermined positions, respectively, in the template text message to build the customized text message.

25. The method according to claim 12 further including the step of not displaying the customized text message to the agent until all of the text storage data has been inserted into the template text message.

26. The method according to claim 12 further including the step of altering the visual appearance of the customized text message until all of the text storage data has been inserted into the template text message to indicate to the agent that the customized test message is not complete.

27. The method according to claim 12 wherein the agent transmits the customized text message as part of a greeting message or a farewell message.

28. The method according to claim 12 wherein the agent transmits the customized text message during the communication between the caller and the agent when sufficient predetermined text data has been acquired by the agent.

29. The method according to claim 12 wherein the agent generates a plurality of customized messages and transmits the customized messages to the caller with a predetermined time delay between at least two sequential messages.

30. A transaction processing system configured to route incoming calls from callers, to agents associated with the transaction processing system, at least some of the incoming calls based on non-voice dialog communication, the system comprising:
a communication processor operatively incorporated into the transaction processing system and configured to facilitate sending and receiving the non-voice dialog communication between the caller and the agent;
an agent display operatively coupled to the communication processor and configured to display the non-voice dialog communication;
the communication processor including memory for storing predetermined text data selected by the agent during the communication between the agent and the caller;
the communication processor providing a plurality of template text messages each having at least one blank portion capable of receiving the selected predetermined text data;
wherein the agent selects the predetermined text data from the non-voice dialog communication displayed on the agent display and operatively copies the selected predetermined text data into the blank portion of the template text message to create a customized text message, and wherein the agent sends the customized text message to the caller.

31. The system according to claim 30 wherein at least a portion of the text data corresponds to data provided by the caller to the agent.

32. The system according to claim 30 wherein at least a portion of the text data is data contained in a text message sent by the caller.

33. The system according to claim 30 wherein at least a portion of the text data corresponds to data provided by the agent.

34. The system according to claim 30 wherein at least a portion of the text data is obtained from a database.

35. The system according to claim 30 wherein at least a portion of the text data is selected from the group consisting of a customer name, customer account number, product identification, product status, delivery date, delivery completed status, shipping method, and tracking number.

36. The system according to claim 30 wherein a plurality of the template messages is displayed to the agent on a visual displace device.

37. The system according to claim 30 wherein the customized text message is not displayed to the agent until all of the text storage data has been inserted into the template text message.

38. The system according to claim 30 wherein the visual appearance of the customized text message is altered until all of the text storage data has been inserted into the template text message to indicate to the agent that the customized test message is not complete.

39. A transaction processing system configured to route incoming calls from callers, to agents associated with the transaction processing system, at least some of the incoming calls based on non-voice dialog communication, the system comprising:
a processing means operatively incorporated into the transaction processing system and configured to facilitate sending and receiving the non-voice dialog communication between the caller and the agent;
an agent display operatively coupled to the communication processor and configured to display the non-voice dialog communication;
the processing means including memory for storing predetermined text data selected by the agent during the communication between the agent and the caller;
the processing means providing a plurality of template text messages each having at least one blank portion capable of receiving the selected predetermined text data;
wherein the agent selects the predetermined text data from the non-voice dialog communication displayed on the agent display and operatively copies the selected predetermined text data into the blank portion of the template text message to create a customized text message, and wherein the agent sends the customized text message to the caller.

40. A computer readable memory or data storage means encoded with data representing a computer program for a transaction processing system, the system configured to route incoming calls from callers, to agents associated with the transaction processing system, at least some of the incoming calls based on non-voice dialog communication, the computer readable memory or data storage means comprising:
a processing means for facilitating sending and receiving the non-voice dialog communication between the caller and the agent;
means for displaying the non-voice dialog communication;
the processing means including memory for storing predetermined text data selected by the agent during the communication between the agent and the caller, and for providing a plurality of template text messages each having at least one blank portion capable of receiving the selected predetermined text data; and
means for facilitating agent selection of the predetermined text data from the non-voice dialog communication displayed on the display means and for facilitating copying the selected predetermined text data into the blank portion of the template text message to create a customized text message, and wherein the agent sends the customized text message to the caller.
